(19) United States
(12) Patent Application Publication
(10) Pub. No.: US 2025/0219333 A1
(43) Pub. Date: Jul. 3, 2025

(54) High Voltage Shielded Electrical Connector

(71) Applicant: Lear Corporation, Southfield, MI (US)

(72) Inventors: Zhipeng Bai, Shanghai (CN); Chao Fang, Shanghai (CN)

(73) Assignee: Lear Corporation, Southfield, MI (US)

(21) Appl. No.: 18/928,446

(22) Filed: Oct. 28, 2024

(30) Foreign Application Priority Data
Dec. 27, 2023 (CN) 202311835030.X

(51) Int. Cl. H01R 13/6597; H01R 13/627

(52) U.S. Cl. CPC H01R 13/6597; H01R 13/6275

(57) ABSTRACT

An electrical connector includes a connector housing that defines a connector cavity. A terminal housing adapted to hold one or more electrical terminals is located within the connector cavity. A housing shield is located around the terminal housing at least partially between the terminal housing and the connector housing. The housing shield includes a connection end that is adapted to be placed into electrical communication with an outer conductor of a cable. The housing shield also includes a shield contact opening. A contact shield includes a shield contact end and a housing end. The contact shield has contact arms located between the shield contact end and the housing end. The housing end is located in the shield contact opening. A housing lock located at the housing end engages the terminal housing to retain the contact shield in place relative to the housing shield.

### FIELD

This disclosure relates to an electrical connector. More specifically, this disclosure relates to a high voltage electrical connector with an improved electromagnetic shield.

### BACKGROUND

Electrical components are often connected to each other using conductive cables, and electrical connectors attached to the cables allow the components to be connected at a desired time. For example, electrical components from different sources can be brought together during the manufacture of a larger assembly. In order to reduce electromagnetic interference, it is known to use an outer conductor on a cable and a shield in the electrical connector that is engaged with the outer conductor on the cable. It is desirable to provide an improved electrical connector with an improved electromagnetic shield.

### SUMMARY

Various example electrical connectors are described.

An example electrical connector includes a connector housing. The connector housing defines a connector cavity. A terminal housing is located within the connector cavity. The terminal housing is adapted to hold one or more electrical terminals. A housing shield is located around the terminal housing at least partially between the terminal housing and the connector housing. The housing shield includes a connection end that is adapted to be placed into electrical communication with an outer conductor of a cable. The housing shield also includes a shield contact opening. A contact shield includes a shield contact end and a housing end. The contact shield has contact arms located between the shield contact end and the housing end. The housing end is located in the shield contact opening. A housing lock located at the housing end engages the terminal housing to retain the contact shield in place relative to the housing shield.

Another example includes a terminal cavity that defines a terminal connection axis and a substantially perpendicular terminal contact axis. The connection end of the housing shield is located around the terminal connection axis. The shield contact opening is located around the terminal contact axis.

Another example includes a housing shield that includes a first shield and a second shield. The first shield includes lock tabs that engage the terminal housing to retain the first shield in place relative to the terminal housing. The first shield also includes an overlap tab that extends from a first shield body. The second shield includes second lock tabs that engage the terminal housing to retain the second shield in place relative to the terminal housing. The second shield also includes an overlap seat defined in a second shield body. The overlap tab on the first shield is located in the overlap seat. The second shield includes extensions that extend from the second shield body and that cover at least part of a seam between the first shield and the second shield. The housing shield further includes a shield seat that is located within the shield contact opening. The contact shield includes shield arms that extend from a contact shield body and engage the shield seat.

Additional understanding of these examples will become apparent to those skilled in the art from the following detailed description, when read in light of the accompanying drawings.

### BRIEF DESCRIPTION OF THE DRAWINGS

FIG. 1 is a perspective view of an example 90-degree electrical connector.

FIG. 2 is a partially exploded view of the electrical connector illustrated in FIG. 1, showing an outer assembly and an inner assembly.

FIG. 3 is a partially exploded view of the inner assembly illustrated in FIG. 2.

FIG. 4 is a view similar to FIG. 3 with the inner assembly shown partially assembled.

FIG. 5 is a cross-sectional view taken through the line 5-5 in FIG. 1.

FIG. 6 is a perspective view of a connector position assurance from the outer assembly.

FIG. 7 is a cross-sectional view taken through the line 7-7 in FIG. 5, showing a connector position assurance in a pre-lock position.

FIG. 8 is a view similar to FIG. 7, showing the connector position assurance moved to a locked position.

FIG. 9 is a view similar to FIG. 8, with an assurance latch on the connector position assurance shown moved to a release position.

FIG. 10 is a cross-sectional view taken along the line 10-10 in FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

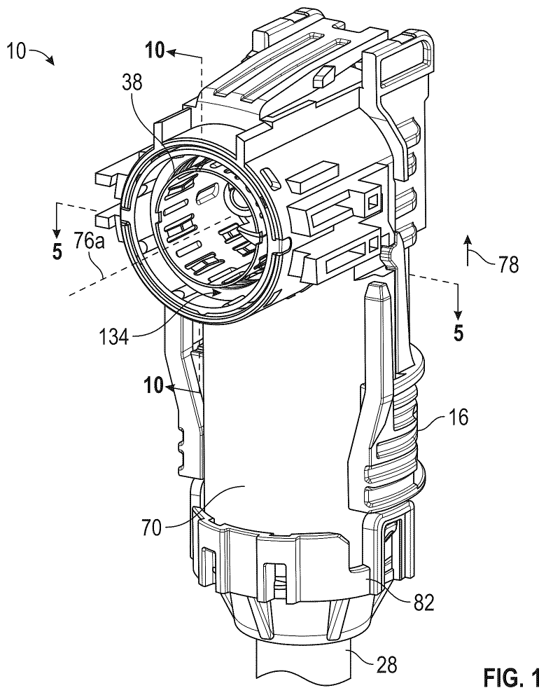

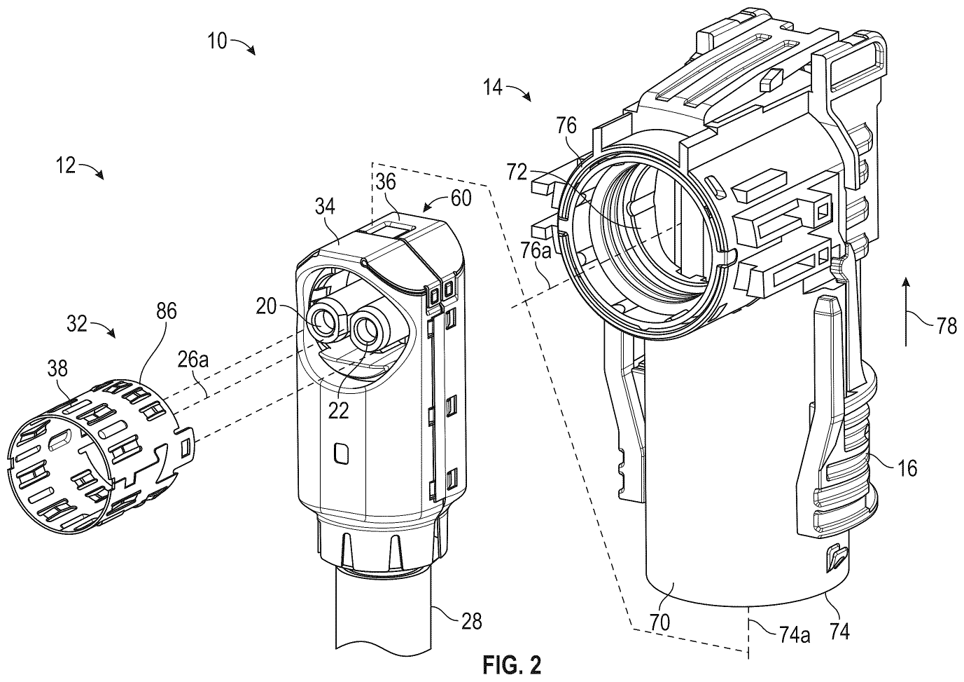

Referring now to the drawings there is illustrated is FIG. 1 a front perspective view of an electrical connector, indicated generally at 10. The illustrated electrical connector is a 90-degree connector but may be any desired type of connector. FIG. 2 is a partially exploded view of the electrical connector 10, showing an inner assembly, indicated generally at 12, and an outer assembly, indicated generally at 14, that includes a connector position assurance 16.

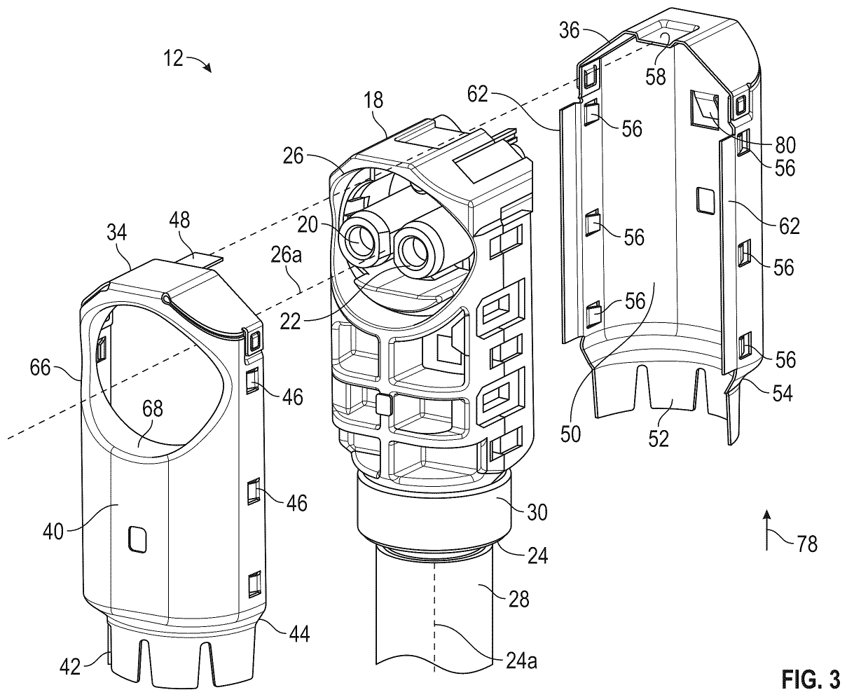

Referring to FIG. 3, there is illustrated a partially exploded view of the inner assembly 12. The inner assembly 12 includes a terminal housing 18. The illustrated terminal housing 18 is a two-piece assembly and both pieces are molded from plastic, but the terminal housing 18 may be made of any desired material and by any desired process. The illustrated terminal housing 18 includes two terminal cavities 20 and 22, each of which is adapted to accommodate an electrical terminal (not shown). The illustrated terminal cavities 20 and 22 are 90-degree cavities and each cavity includes an opening at a connection end 24 of the terminal housing 18 and at a contact end 26 of the terminal housing 18. Each electrical terminal is adapted to be connected to a respective electrical conductor (not shown) that will enter the terminal housing 18 at the connection end 24, generally parallel to a terminal connection axis 24a. The electrical conductors are located in a cable 28. Additionally, each electrical terminal is adapted to engage a corresponding terminal (not shown) that will enter the terminal housing 18 at the contact end 26, generally parallel to a terminal contact axis 26a.

The illustrated cable 28 is a shield cable and includes an outer conductor (not shown) that is electrically connected to a ferrule 30 during assembly of the inner assembly 12. The ferrule 30 is made of electrically conductive metal and is pressed onto the terminal housing 18.

Referring back to FIG. 2, the inner assembly 12 includes a shield, indicated generally at 32. The illustrated shield includes a first shield 34, a second shield 36, and a contact shield 38. The illustrated first shield 34, second shield 36, and contact shield 38 are made of sheet metal folded into the illustrated shapes. However, the first shield 34, second shield 36, and contact shield 38 may be made of any desired materials and by any desired process.

Referring to FIG. 3, there is illustrated a perspective view of the terminal housing 18 as well as the first shield 34 and the second shield 36. The first shield 34 includes a first shield body 40. The first shield body 40 is shaped and sized to fit around part of an exterior of the terminal housing 18. The first shield body 40 includes a plurality of connection tabs 42 at a connection end 44 of the first shield body 40. The connection tabs 42 are adapted to provide an electrical connection between the first shield 34 and the outer conductor of the cable 28.

The first shield 34 includes a plurality of lock tabs 46 that extend inwardly from the first shield body 40. The lock tabs 46 are adapted to retain the first shield 34 on the terminal housing 18, as described below. The first shield 34 also includes an overlap tab 48 that extends from the first shield body 40. The overlap tab 48 is adapted to provide electrical communication between the first shield 34 and the second shield 36, as described below.

The second shield 36 includes a second shield body 50. The second shield body 50 is shaped and sized to fit around a second part of the exterior of the terminal housing 18. The second shield body 50 includes a second plurality of connection tabs 52 at a connection end 54 of the second shield body 50. The connection tabs 52 are adapted to provide an electrical connection between the second shield 36 and the outer conductor of the cable 28.

The second shield 36 includes a second plurality of second lock tabs 56 that extend inwardly from the second shield body 50. The second lock tabs 56 are adapted to retain the second shield 36 on the terminal housing 18, as described below. The second shield 36 also includes an overlap seat 58 on the second shield body 50. The illustrated overlap seat 58 is embossed on an outer surface of the second shield body 50. However, the overlap seat 58 may have any desired shape and be in any desired location. The overlap seat 58 is adapted accommodate the overlap tab 48, to provide electrical communication between the first shield 34 and the second shield 36, as described below.

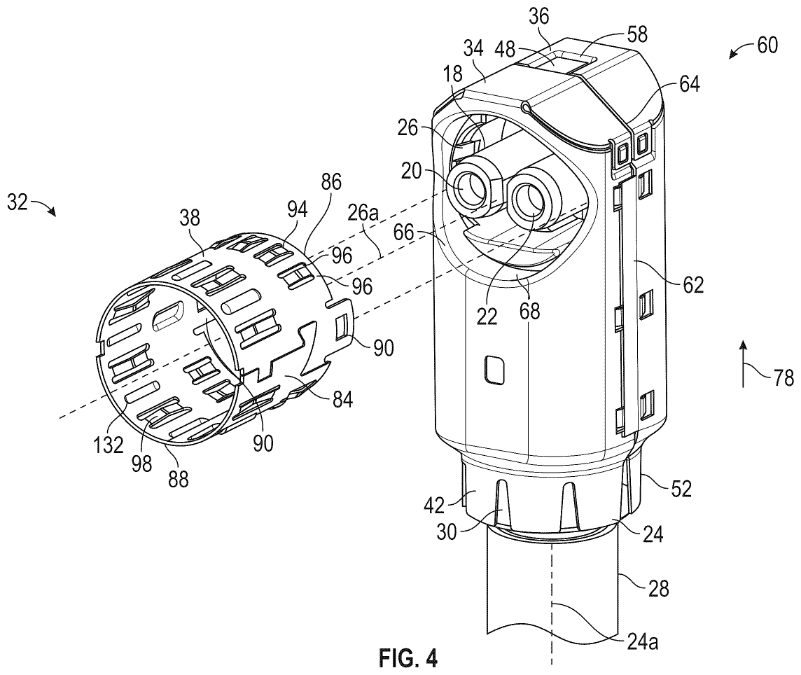

Referring to FIG. 4, there is illustrated a view of the first shield 34 and the second shield 36 attached to the terminal housing 18 to form a housing shield, indicated generally at 60. In order to attach the first shield 34 to the terminal housing 18, the first shield 34 is first oriented with the cavity defined by the first shield 34 facing the terminal housing 18. The first shield 34 is then moved perpendicular to the terminal connection axis 24a relative to the terminal housing 18 until the lock tabs 46 engage the terminal housing 18 to retain the first shield 34 in place. Similarly, in order to attach the second shield 36 to the terminal housing 18, the second shield 36 is first oriented with the cavity defined by the second shield 36 facing the terminal housing 18. The second shield 36 is then moved perpendicular to the terminal connection axis 24a relative to the terminal housing 18 until the second lock tabs 56 engage the terminal housing 18 to retain the second shield 36 in place.

With the housing shield 60 assembled, the overlap tab 48 is located in the overlap seat 58. Additionally, extensions 62 cover at least part of a seam 64 between the first shield 34 and the second shield 36. Referring back to FIG. 3, in the illustrated embodiment the extensions 62 extend from the second shield body 50. However, the extensions 62 may be in any desired location. As shown in FIG. 4, the connection tabs 42 and 52 are positioned adjacent to the ferrule 30, in order to allow for electrical communication between the housing shield 60 and the outer conductor of the cable 28.

The housing shield 60 defines a shield contact opening 66. In the illustrated embodiment, the shield contact opening 66 is located in the first shield 34. However, the shield contact opening 66 may be in any desired part of the housing shield 60. The shield contact opening 66 is located around the terminal cavities 20 and 22 of the terminal housing 18 and is located around the terminal contact axis 26a. The shield contact opening 66 includes a shield seat 68 that extends into the terminal housing 18. The shield seat 68 is adapted to accommodate the contact shield 38, as described below.

Referring back to FIG. 2, the outer assembly 14 includes a connector housing 70. The illustrated connector housing 70 molded from plastic but may be made of any desired material and by any desired process. The connector housing 70 defines a connector cavity 72 extending therethrough. The connector cavity 72 is a 90-degree cavity and includes an opening at a connector connection end 74 and at a connector contact end 76 of the connector housing 70. The connector cavity 72 defines a connector connection axis 74a that passes through the connector connection end 74, and a substantially perpendicular connector contact axis 76a that passes through the connector contact end 76. The connector cavity 72 is adapted to accommodate the inner assembly 12.

In order to connect the inner assembly 12 to the outer assembly 14, the inner assembly 12 is first positioned adjacent to the outer assembly 14, with the terminal connection axis 24a parallel to (and in the illustrated embodiment, coaxial with) the connector connection axis 74a. The inner assembly 12 is then moved parallel to the connector connection axis 74a in an assembly direction 78 towards the outer assembly 14, so that the inner assembly 12 enters the connector cavity 72 at the connector connection end 74. Referring to FIG. 3, the inner assembly 12 includes a lock 80 that is adapted to retain the inner assembly 12 in the connector cavity 72. The illustrated lock 80 is cut from the second shield 36 but may be on any desired part of the inner assembly 12. When the inner assembly 12 is moved in the assembly direction 78 relative to the connector housing 70 to an assembled position, the lock 80 engages the connector housing 70 in order to retain the inner assembly 12 in the assembled position. Referring back to FIG. 1, an endcap 82 located around the cable 28 is then attached to the connector housing 70 in order to further retain the inner assembly 12 in the assembled position. The terminal housing 18 is then located within the connector cavity 72 of the connector housing 70 and it retained therein. Additionally, the housing shield 60 is located at least partially between the terminal housing 18 and the connector housing 70.

Referring back to FIG. 4, the contact shield 38 includes a contact shield body 84. The illustrated contact shield body 84 has a circular cross-sectional shape but may have any desired shape. The contact shield body 84 extends from a housing end 86 to a shield contact end 88. The contact shield 38 includes housing locks 90 that are located at and extend from the housing end 86. The illustrated contact shield 38 includes two housing locks 90 but may include any desired number.

In order the connect the contact shield 38 to the housing shield 60, as shown in FIGS. 2 and 4, the contact shield 38 is positioned adjacent to the connector housing 70, around the connector contact axis 76a, with the housing end 86 facing the connector contact end 76. The contact shield 38 is then moved towards the connector housing 70 so that the contact shield 38 enters the connector cavity 72 and the housing end 86 is located in the shield seat 68. This position is illustrated in FIG. 1.

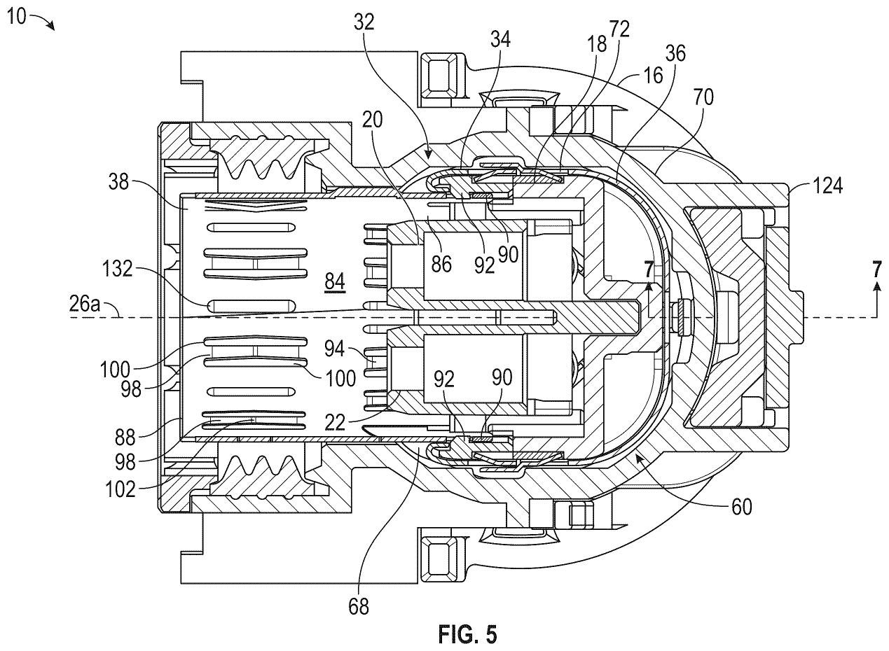

FIG. 5 is a cross-sectional view taken long the line 5-5 of FIG. 1. Each of the housing locks 90 engages a respective catch 92 located on the terminal housing 18 to retain the contact shield 38 in place relative to the terminal housing 18 and the housing shield 60.

Referring back to FIG. 4, the contact shield 38 includes a plurality of shield arms 94 located near the housing end 86 and between the housing end 86 and the shield contact end 88. Each shield arm 94 is cut from the contact shield body 84 and includes axial cuts 96 on either side. Each shield arm 94 is connected to the contact shield body 84 at either end, and is bent outwardly, away from the terminal contact axis 26a. When the contact shield 38 is connected to the housing shield 60, the shield arms 94 engage the shield seat 68, as shown in FIG. 5, to provide electrical communication between the contact shield 38 and the housing shield 60.

The contact shield 38 includes a plurality of contact arms 98 located near the shield contact end 88 of the contact shield body 84 and between the housing end 86 and the shield contact end 88. The contact arms 98 are adapted to provide an electrical connection between the contact shield 38 and a corresponding shield (not shown) on a corresponding connector (not shown). Each illustrated contact arm 98 is connected to the contact shield body 84 at opposite axial ends and includes an axial cut 100 on either side. The illustrated contact arms 98 are bent inwardly, towards the terminal contact axis 26a, to a respective contact region 102. The contact arms 98 are adapted to engage the corresponding shield on the corresponding connector when the electrical connector 10 is mated with the corresponding connector, in order to provide electrical communication between the corresponding shield, the contact shield 38, the housing shield 60, and the outer conductor of the cable 28.

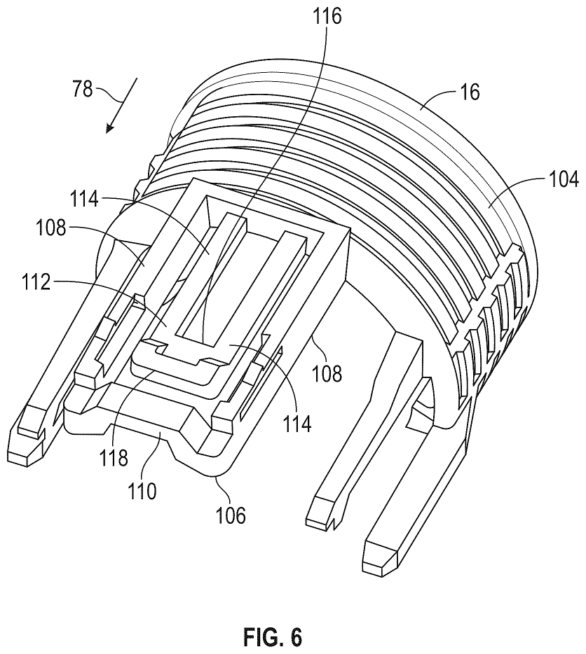

Referring to FIG. 6 there is illustrated a front perspective view of the connector position assurance 16 from FIG. 1. The illustrated connector position assurance 16 is molded from plastic. However, the connector position assurance 16 may be made of any desired material and by and desired process. The connector position assurance 16 includes an assurance body 104. The illustrated assurance body 104 has a semi-circular cross-sectional shape and is adapted to fit around the outside of the connector housing 70, as shown in FIGS. 1 and 2. The connector position assurance 16 is attached to the connector housing 70 for relative movement from a pre-lock position (shown in FIGS. 1 and 2) to a locked position.

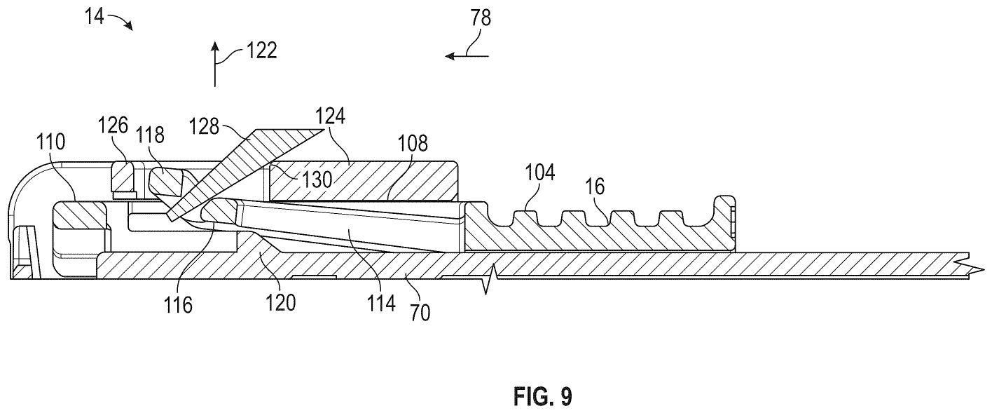

As shown in FIGS. 6 and 9, the connector position assurance 16 includes an assurance block 106 that is fixed to the assurance body 104. The assurance block 106 includes two guide arms 108 that extend from the assurance body 104 in the assembly direction 78. An assurance stop 110 is connected to the two guide arms 108 at outer ends thereof. The connector position assurance 16 also includes an assurance latch 112 that is attached to the assurance body 104. The assurance latch 112 includes two latch arms 114 that extend from the assurance body 104 in the assembly direction 78. In the illustrated embodiment, the two latch arms 114 are located between the guide arms 108. An assurance catch 116 is connected to the two latch arms 114 near outer ends thereof. The assurance latch 112 also includes a lift bar 118. The illustrated lift bar 118 is connected to the two latch arms 114 at the outer ends thereof.

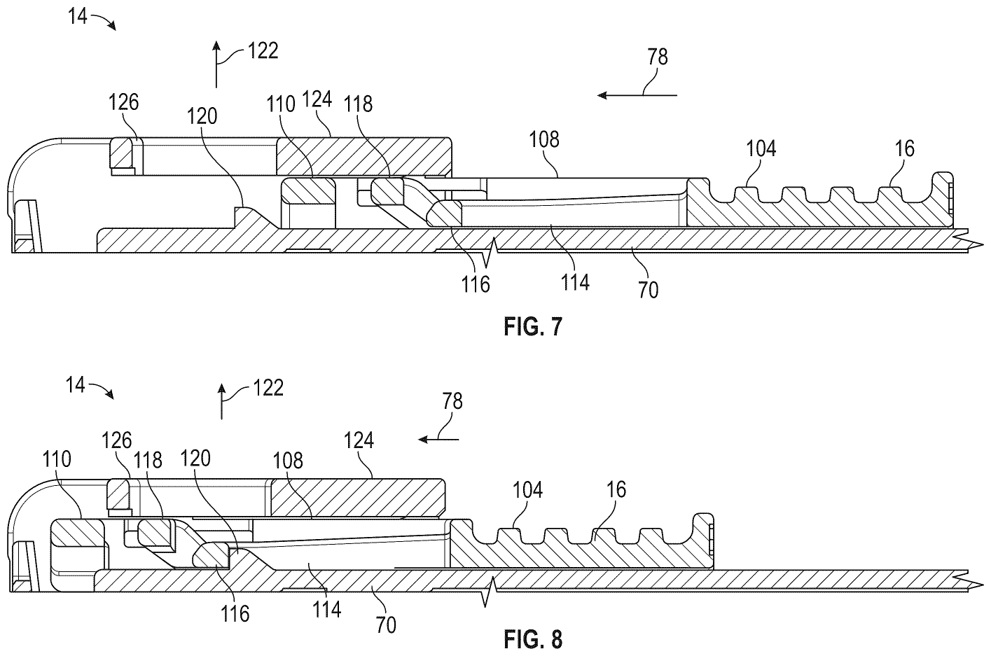

Referring to FIG. 7, there is illustrated a cross-sectional view taken along the line 7-7 of FIG. 5. FIG. 7 illustrates a portion of the outer assembly 14, including the connector position assurance 16 in the pre-lock position. In order to move the connector position assurance 16 to the locked position, the connector position assurance 16 is moved in the assembly direction 78 relative to the connector housing 70. The connector housing 70 includes a housing catch 120 that is located in the assembly direction 78 from the assurance catch 116. When the connector position assurance 16 is moved from the pre-lock position towards the locked position, the housing catch 120 engages the assurance catch 116, and the assurance catch 116 is pushed in a release direction 122 away from the connector housing 70. This causes the latch arms 114 to bend relative to the assurance body 104, and both the assurance catch 116 and the lift bar 118 are moved to a release position.

When the connector position assurance 16 is moved farther in the assembly direction 78 relative to the connector housing 70 to the locked position, the housing catch 120 no longer engages the assurance catch 116, and the assurance catch 116 is able to rebound opposite the release direction 122 toward the connector housing 70. This puts the connector position assurance 16 in the locked position, illustrated in FIG. 8. When the connector position assurance 16 is in the locked position, the housing catch 120 engages the assurance catch 116 to prevent the connector position assurance 16 from being moved opposite the assembly direction 78 towards the pre-lock position.

The connector housing 70 includes a shroud 124 that is located in the release direction 122 from at least part of the connector position assurance 16. The shroud 124 defines a window 126. As shown in FIG. 8, when the connector position assurance 16 in the locked position, the window allows access to the lift bar 118. In the illustrated embodiment, at least part of the window 126 is located in the release direction 122 from the lift bar 118 when the connector position assurance 16 in the locked position.

As shown in FIG. 9, in order to move the connector position assurance 16 from the locked position opposite the assembly direction 78 towards the pre-lock position, an operator may insert a tool 128 through the window 126 to engage the lift bar 118 on the assurance latch 112. The illustrated tool 128 is a screwdriver but may be any desired type of device. The window 126 includes a pry surface 130 on which the operator may rest the tool 128 to act as a fulcrum in order to apply a levered force on the lift bar 118. By applying a force on the lift bar 118, the assurance latch 112 is able to be moved in the release direction 122 relative to the connector housing 70 to the release position. This also moves the assurance catch 116 relative to the connector housing 70 and relative to the housing catch 120.

When the assurance latch 112 is in the release position, the connector position assurance 16 is able to be moved relative to the connector housing 70 toward the pre-lock position. The operator may release the force on the lift bar 118 to allow the assurance latch 112 to rebound from the release position, while the connector position assurance 16 is moved to the pre-lock position shown in FIG. 7.

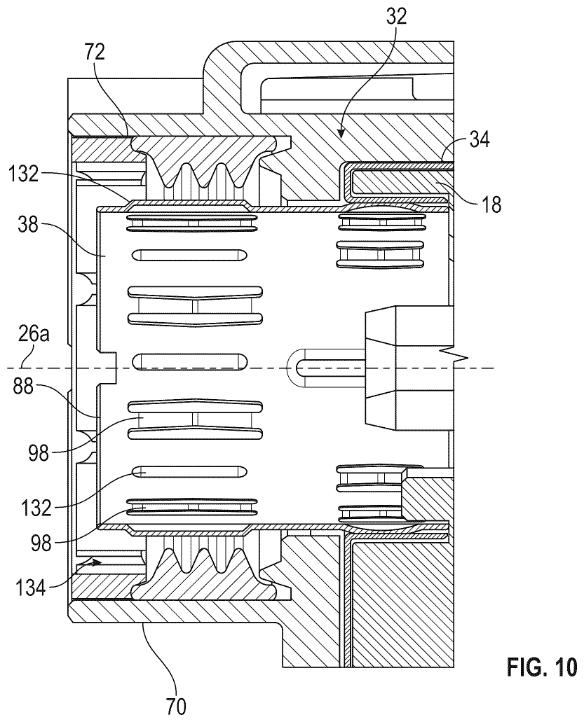

Referring back to FIG. 4, the contact shield 38 includes a plurality of ridges 132 located near the connection end 44 and between the housing end 86 and the shield contact end 88. In the illustrated embodiment, there is one ridge 132 between adjacent contact arms 98. The illustrated ridges 132 are outward projections embossed in the contact shield 38. Referring to FIG. 10, there is illustrated a cross-sectional view taken along the line 10-10 of FIG. 1, taken through one of the ridges 132. As shown, when the electrical connector 10 is assembled, the contact shield 38 is located in the connector cavity 72 with a space 134 defined between the contact shield 38 and the side wall of the connector cavity 72. As shown in FIG. 1, the space 134 extends around the whole shield contact end 88 of the contact shield 38. As shown in FIG. 10, the ridges 132 extend into the space 134. When the electrical connector 10 is mated with the corresponding connector, part of the corresponding connector is located in the space 134. The ridges 132 are adapted to engage the corresponding connector to press the contact arms 98 inwardly towards the terminal contact axis 26a and into engagement with the corresponding shield.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector comprising:
a connector housing defining a connector cavity;
a terminal housing located within the connector cavity, the terminal housing adapted to hold one or more electrical terminals;
a housing shield located around the terminal housing at least partially between the terminal housing and the connector housing, the housing shield including a connection end and a shield contact opening, the connection end adapted to be placed into electrical communication with an outer conductor of a cable; and
a contact shield including a shield contact end, a housing end, a housing lock, and contact arms, the contact arms located between the shield contact end and the housing end, the housing end located in the shield contact opening, the housing lock located at the housing end and engaging the terminal housing to retain the contact shield in place relative to the housing shield.

2. The electrical connector of claim 1, wherein the housing shield includes a shield seat; and
wherein the contact shield has a contact shield body and includes shield arms that extend from the contact shield body and engage the shield seat.

3. The electrical connector of claim 1, wherein the housing shield includes a first shield and a second shield, the first shield including lock tabs that engage the terminal housing to retain the first shield in place relative to the terminal housing, the second shield including second lock tabs that engage the terminal housing to retain the second shield in place relative to the terminal housing; and
wherein the shield contact opening is located in the first shield.

4. The electrical connector of claim 3, wherein the first shield includes a shield seat and the contact shield includes shield arms that extend from a contact shield body and engage the shield seat of the first shield.

5. The electrical connector of claim 3, wherein the first shield includes a first shield body and an overlap tab that extends from the first shield body;
wherein the second shield includes a second shield body and an overlap seat; and
wherein the overlap tab is located in the overlap seat.

6. The electrical connector of claim 3, wherein the second shield includes extensions that extend from a second shield body and that cover at least part of a seam between the first shield and the second shield.

7. The electrical connector of claim 6, wherein the first shield includes a shield seat and the contact shield includes shield arms that extend from a contact shield body and engage the shield seat.

8. The electrical connector of claim 7, wherein the first shield includes a first shield body and an overlap tab that extends from the first shield body.

9. The electrical connector of claim 8, wherein the second shield includes a second shield body and an overlap seat; and
wherein the overlap tab is located in the overlap seat.

10. The electrical connector of claim 1, further comprising a connector position assurance attached to the connector housing, the connector position assurance moveable relative to the connector housing between a pre-lock position and a locked position, the connector position assurance including an assurance latch; and
wherein the connector housing includes a housing catch that engages the connector position assurance to deflect the assurance latch in a release direction relative to the connector housing to a release position when the connector position assurance is moved from the pre-lock position toward the locked position, and that engages the connector position assurance to prevent movement of the connector position assurance from the locked position to the pre-lock position.

11. The electrical connector of claim 10, wherein the connector housing includes a shroud that is located in the release direction from at least part of the connector position assurance, the shroud defining a window; and
wherein the assurance latch has a lift bar accessible through the window when the connector position assurance in the locked position.

12. The electrical connector of claim 1, wherein the contact shield has a plurality of ridges located between the housing end and the shield contact end.

13. The electrical connector of claim 1, wherein the contact shield has a ridge located between adjacent contact arms.

14. The electrical connector of claim 13, wherein the ridge extends outwardly from a contact shield body into the connector cavity.

15. The electrical connector of claim 14, wherein the contact arms extend inwardly from the contact shield body.

16. The electrical connector of claim 1, wherein the terminal housing defines a terminal connection axis and the connection end of the housing shield is located around the terminal connection axis; and
wherein the terminal housing defines a terminal contact axis and the contact shield is located around the terminal contact axis; and
wherein the terminal connection axis is substantially perpendicular to the terminal contact axis.

17. An electrical connector comprising:
a connector housing defining a connector cavity;
a terminal housing located within the connector cavity, the terminal housing adapted to hold one or more electrical terminals and defining a terminal connection axis and a terminal contact axis substantially perpendicular to the terminal connection axis;
a housing shield located around the terminal housing at least partially between the terminal housing and the connector housing, the housing shield including a connection end and a shield contact opening, the connection end adapted to be placed into electrical communication with an outer conductor of a cable and located around the terminal connection axis, the shield contact opening located around the terminal contact axis; and
a contact shield located around the terminal contact axis and including a shield contact end, a housing end, a housing lock, and contact arms, the contact arms located between the shield contact end and the housing end, the housing end located in the shield contact opening, the housing lock located at the housing end and engaging the terminal housing to retain the contact shield in place relative to the housing shield.

18. The electrical connector of claim 17, wherein the housing shield includes a shield seat; and
wherein the contact shield has a contact shield body and includes shield arms that extend from the contact shield body and engage the shield seat.

19. The electrical connector of claim 17, wherein the housing shield includes a first shield and a second shield, the first shield including lock tabs that engage the terminal housing to retain the first shield in place relative to the terminal housing, the second shield including second lock tabs to retain the second shield in place relative to the terminal housing; and
wherein the shield contact opening is located in the first shield.

20. An electrical connector comprising:
a connector housing defining a connector cavity;
a terminal housing located within the connector cavity, the terminal housing adapted to hold one or more electrical terminals and defining a terminal connection axis and a terminal contact axis substantially perpendicular to the terminal connection axis;
a housing shield located around the terminal housing at least partially between the terminal housing and the connector housing, the housing shield including a connection end adapted to be placed into electrical communication with an outer conductor of a cable and located around the terminal connection axis,
the housing shield including a first shield and a second shield, the first shield including lock tabs that engage the terminal housing to retain the first shield in place relative to the terminal housing, the first shield including a first shield body and an overlap tab that extends from the first shield body, the second shield including second lock tabs that engage the terminal housing to retain the second shield in place relative to the terminal housing, the second shield including a second shield body and an overlap seat, wherein the overlap tab is located in the overlap seat, the second shield including extensions that extend from the second shield body and that cover at least part of a seam between the first shield and the second shield, the housing shield including a shield contact opening that is located around the terminal contact axis, and including a shield seat that is located within the shield contact opening; and
a contact shield located around the terminal contact axis and including a shield contact end, a housing end, a housing lock, contact arms, a contact shield body, and shield arms, the contact arms located between the shield contact end and the housing end, the housing end located in the shield contact opening, the shield arms extend from the contact shield body and engage the shield seat, the housing lock located at the housing end and engaging the terminal housing to retain the contact shield in place relative to the housing shield.
